(19) United States
(12) Patent Application Publication
(10) Pub. No.: US 2023/0024130 A1
(43) Pub. Date: Jan. 26, 2023

(54) WORKLOAD AWARE VIRTUAL PROCESSING UNITS

(71) Applicant: ADVANCED MICRO DEVICES, INC., Santa Clara, CA (US)

(72) Inventors: Anirudh ACHARYA, San Diego, CA (US); Sreekanth GODEY, Santa Clara, CA (US); Ruijin WU, San Diego, CA (US)

(21) Appl. No.: 17/564,166

(22) Filed: Dec. 28, 2021

Related U.S. Application Data
(60) Provisional application No. 63/225,433, filed on Jul. 23, 2021.

(51) Int. Cl. G06F 9/50

(52) U.S. Cl. CPC G06F 9/505; G06F 9/5038; G06F 9/5077; G06F 9/5044

(57) ABSTRACT

A processing unit is configured differently based on an identified workload, and each configuration of the processing unit is exposed to software (e.g., to a device driver) as a different virtual processing unit. Using these techniques, a processing system is able to provide different configurations of the processing unit to support different types of workloads, thereby conserving system resources. Further, by exposing the different configurations as different virtual processing units, the processing system is able to use existing device drivers or other system infrastructure to implement the different processing unit configurations.

### BACKGROUND

To enhance processing efficiency, some processing systems employ specially designed and configured processing units to perform specified tasks that are performed less efficiently by general-purpose processing units. For example, some processing systems employ one or more graphics processing units (GPUs) configured to perform graphics and vector processing operations on behalf of one or more central processing units (CPUs). A CPU sends specified commands (e.g., draw commands) to a GPU, which executes the graphics or vector processing operations indicated by the commands. However, while enhancing processing efficiency, in some cases the specially designed and configured circuitry of a GPU or other processing unit consumes an undesirably large number of system resources.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a graphics processing unit (GPU) configured to expose a virtual GPU based upon an identified workload in accordance with some embodiments.

FIG. 2 is a block diagram illustrating an example of the GPU of FIG. 1 exposing different virtual GPUs to a device driver based upon different identified workloads in accordance with some embodiments.

FIG. 3 is a block diagram illustrating different workload indicators used to identify a workload at the GPU of FIG. 1 in accordance with some embodiments.

FIG. 4 is a flow diagram illustrating a method of exposing different virtual processing units to a device driver based upon different identified workloads in accordance with some embodiments.

### DETAILED DESCRIPTION

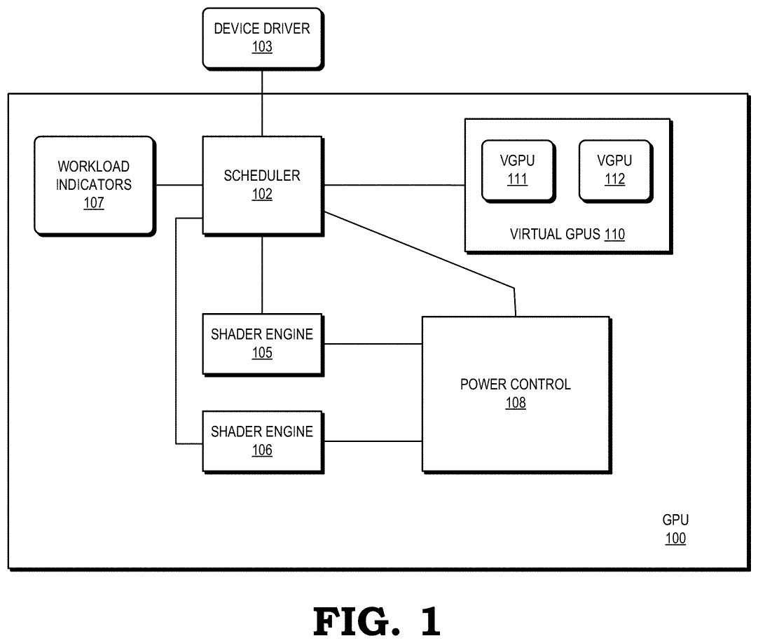

FIGS. 1-4 illustrate techniques for configuring a processing unit differently based on an identified workload, and exposing each configuration of the processing unit to software (e.g., to a device driver) as a different virtual processing unit. Using these techniques a processing system is able to provide different configurations of the processing unit to support different types of workloads, thereby conserving system resources. Further, by exposing the different configurations as different virtual processing units, the processing system is able to use existing device drivers or other system infrastructure to implement the different processing unit configurations.

To illustrate, in some embodiments a processing system includes a GPU to execute graphics operations for a central processing unit (CPU). An application program executing at the CPU sends commands (e.g., draw commands), and based on the commands the GPU executes a set of operations to perform tasks indicated by the commands. The set of operations for one or more commands is referred to as a workload. In some cases the workloads, and corresponding operations, vary widely between different applications, or between different phases of a single application. Further, at least some of the varying workloads will not productively use at least a portion of the resources of the GPU. Accordingly, different configurations of the GPU are able to satisfy the processing requirements of different workloads for improved balance between performance and power consumption.

Using the techniques herein, a GPU is able to change configuration based on an identified workload, thereby tailoring the resources of the GPU for a given workload, and conserving resources that are not required. For example, in some embodiments, for a relatively light workload (e.g., a workload requiring relatively few shading operations), the GPU is configured so that only a relatively small subset of available workgroup processors are in an active mode, with the remaining workgroup processors placed in a low-power mode. For a relatively heavy workload (e.g., a game application requiring a large number of shading operations), the GPU is configured so that a higher number of workgroup processors are placed in an active mode. Thus, for lighter workloads, the GPU is configured so that power and other system resources are conserved while still providing enough resources for satisfactory execution of the workload. For heavier workloads, the GPU is configured so that more system resources are available, thereby ensuring satisfactory execution of the heavier workload. Accordingly, as the workload at the GPU varies, the configuration of the GPU is varied, thereby conserving resources while maintaining satisfactory performance.

Further, each of the configurations of the GPU is exposed to a device driver or other software as a virtual GPU. This allows the device driver to use existing communication protocols and existing commands to interact with each of the different GPU configurations. That is, the user-mode device driver is not required to be redesigned or altered to interact with each of the different GPU configurations, thus simplifying the overall implementation of multiple GPU configurations.

In some embodiments, the GPU identifies the workload to be executed based on one or more of a plurality of factors, such as workload metadata provided by an application, offline application profiling, runtime profiling, software hints, and the like, or any combination thereof. For example, in some embodiments an application provides metadata indicating the resource requirements for a workload, such as a number of draw calls, a number of dispatches, a number of primitives, a number of workgroups, shader complexity, and the like, or a combination thereof, and the GPU identifies the workload based on this metadata.

In other embodiments, the workloads generated by an application are identified and profiled in a test environment, and stored as a set of workload profiles. When the application is executed in a non-test environment, the GPU accesses the stored set of workload profiles to identify the executing workload.

In still other embodiments, the GPU identifies the workload dynamically during runtime. For example, in some cases the GPU records information in a set of performance counters, such as cache hits, cache misses, memory accesses, number of draw calls, shader instructions, and the like. Using the information in the performance counters, the GPU profiles an executing workload. When the workload is subsequently executed again, the GPU uses the profile to determine the GPU configuration.

In some other embodiments, an executing application provides a software hint indicating the type of application that is executing. Based on the application type, the GPU identifies the workload and the corresponding configuration. For example, if the application type indicates a game application, the GPU typically identifies the workload as a heavy workload, and employs a configuration with a relatively high number of active system resources (e.g., a high number of workgroup processors in an active mode). If the application type indicates a word processing application, the GPU identifies the workload as a relatively light workload, and employs a configuration with a relatively low number of active system resources (e.g., a relatively high number of workgroup processors in a low-power mode).

It will be appreciated that while the above examples, and the example embodiments described with respect to FIGS. 1-4 below, are described with respect to a GPU, in other embodiments the techniques described herein are implemented at a different type of processing unit, such as a vector processing unit, parallel processor, machine learning processing unit, single-instruction multiple-data (SIMD) processing unit, artificial intelligence processing unit, and the like.

In some embodiments, the different configurations of the GPU are programmable, and can therefore be adjusted by an operating system or an application executing at the CPU. This allows software developers to control the configuration of the GPU according to the resource needs of the application, or to adjust the GPU configuration for different phases of the application. Further, in some embodiments a user is able to adjust the configurations via a graphical user interface (GUI) or other interface to tailor the configuration for the objectives of the individual user. For example, a user that desires more power savings (such as user of a laptop system) is able to adjust the configurations to use fewer system resources, thereby reducing the amount of power consumed by one or more of the configurations.

It will be appreciated that while the above examples, and the example embodiments described with respect to FIGS. 1-4 below, are described with respect to a GPU, in other embodiments the techniques described herein are implemented at a different type of processing unit, such as a vector processing unit, parallel processor, machine learning processing unit, single-instruction multiple-data (SIMD) processing unit, artificial intelligence processing unit, and the like.

FIG. 1 illustrates a GPU 100 that is configured to expose a virtual GPU based upon an identified workload in accordance with some embodiments. The GPU is incorporated into a processing system with one or more central processing units (CPUs), and performs graphics operations based on commands received from the one or more CPUs. Accordingly, in different embodiments, the GPU 100 is part of any one of a variety of electronic devices, such as a desktop computer, laptop computer, server, tablet, smartphone, game console, and the like.

The GPU 100 is generally configured to execute commands (e.g., draw commands) received from a device driver 103. In some embodiments, the device driver 103 is software executed at a CPU, and provides an interface between the GPU and one or more applications at the CPU. For example, in some embodiments the CPU executes an operating system (OS) and one or more applications. The applications provide commands to the device driver 103 via the OS. The device driver 103 translates the commands to a format expected by the GPU 100. The device driver 103 thus provides a layer of abstraction between the GPU 100 and applications executing at the CPU.

To support execution of the received commands, the GPU 100 includes a scheduler 102 and shader engines 105 and 106. It will be appreciated that, in some embodiments, the GPU 100 includes additional circuits and modules to support execution of the received commands, such as memory modules to support a memory hierarchy (e.g., a set of caches) for the GPU 100, a command processor to manage receipt and execution of the received commands, processing elements in addition to the shader engines 105 and 106, and the like. In addition, it will be appreciated that one or more of the functions described herein with respect to a particular module are, in some embodiments, performed by a different circuit or module. For example, in some embodiments, the scheduler 102 is part of a command processor of the GPU 100, and one or more of the functions described herein with respect to the scheduler 102 are performed by another module of the command processor.

The scheduler 102 is generally configured to receive commands from the device driver 104 and to generate one or more sets of operations, for execution at processing elements of the shader engines 105 and 106. A set of operations generated by the scheduler 102 for execution based on one or more commands is referred to herein as a workload of the GPU 100. Thus, based on the commands received from the device driver 104, the scheduler 102 generates one or more workloads, and schedules the operations of the one or more workloads for execution at the shader engines 105 and 106. In some embodiments, the scheduler identifies the beginning or end of a given workload based on one or more tokens inserted by a user-mode device driver in a command, such as one or more tokens based on an image frame boundary.

The shader engines 105 and 106 are a set of modules each configured to perform shading and other graphics operations based on the workloads received from the scheduler 102. In some embodiments, each of the shader engines includes a plurality of workgroup processors (WGPs), with each WGP including a plurality of compute units configured to perform programmable parallel operations (e.g., vector arithmetic operations) on received data. For example, in some embodiments each compute unit includes a plurality of single instruction, multiple data (SIMD) units configured to perform programmable parallel operations on a set of received data. The WGPs, compute units, and SIMD units are generally referred to as processing elements herein. In some embodiments, in addition to the above-mentioned processing elements, each of the shader engines includes additional modules, such as a primitive unit to execute graphics primitive operations, a rasterizer, one or more render backends, and one or more caches to store data for the processing elements.

In some embodiments, one or more of the processing elements of the shader engines 105 and 106 are able to be placed in multiple power modes, with each power mode representing a different level of power consumption and corresponding level of processing ability at the processing element. For example, in some embodiments, the WGPs of each shader engine are able to be independently placed in an active mode, wherein the WGP is able to perform processing operations normally, and consumes a relatively high amount of power, and a low-power mode, wherein the WGP is not able to perform normal processing operations but consumes a relatively low amount of power. In some embodiments, when a WGP is placed in the low-power mode, the modules of the WGP are power-gated, so that power from a voltage rail is not applied to the WGP modules.

The power modes of the different processing elements are controlled by a power control module 108, based on control signaling provided by the scheduler 102. Accordingly, in some embodiments, the control signaling, as controlled by the scheduler 102, individually sets the power mode for each WGP of the shader engines 105 and 106. Thus, in some cases, at least one WGP of the shader engines 105 and 106 is set to the active mode while at least one other WGP is set to the low-power mode, so that the different WGPs are concurrently in the active and low-power modes, respectively. In some embodiments, the power control module 108 sets the power mode for different levels of granularity of the processing elements. Thus, in some embodiments, the power control module 108 sets power modes at the level of the WGPs, the compute units, the SIMD units, or other level, or any combination thereof. For purposes of description, it is assumed that the power control module 108 sets power modes at the WGP level.

In some embodiments, the scheduler 102 is configured to identify the workload provided, or expected to be provided, by the device driver 103 based on a set of workload indicators 107. In different embodiments, the workload indicators 107 includes or incorporates different factors, such as workload metadata provided by an application, offline application profiling information, runtime profiling information, software hints, and the like, or any combination thereof. For example, in some embodiments the device driver 103 provides metadata indicating the expected processing demands for a workload, such as a number of draw calls, a number of dispatches, a number of primitives, a number of workgroups, and the like, or a combination thereof, for the workload to be executed.

In some embodiments, the workload indicators 107 are not indicators for a current workload to be executed, but instead are hints as to a workload that is expected to be executed at the GPU 100 in the future. For example, in some embodiments the scheduler 102 records patterns of workloads received from a particular program. Based on these patterns, the scheduler 102 generates the workload indicators 107 to indicate workloads expected to be executed in the future. For example, if the patterns indicate that a Workload B is frequently executed after execution of a Workload A, in response to executing Workload A the scheduler 102 sets the workload indicators 107 to indicate the Workload B.

Based on the identified workload, the scheduler 102 provides control signaling to the power control module 108 to set the power mode for each WGP of the shader engines 105 and 106. For example, in some embodiments, if the workload indicators 107 indicate that the expected workload is one that requires a relatively high amount of processing power to execute efficiently, the scheduler 102 instructs the power control module 108 to set a higher number of the WGPs to the active mode. If, in contrast, the workload indicators 107 indicate that the expected workload is one that requires a lower amount of processing power, the scheduler 102 instructs the power control module 108 to a set a lower number of WGPs to the active mode, and a higher number of WGPs to the low-power mode, thus conserving power. For ease of description, the particular setting of the processing elements of the shaders 105 and 106 is referred to herein as the “power configuration” of the shaders. Thus, the scheduler 102 is configured to set the power configuration of the shaders 105 and 106 based on the workload indicators 107. For example, in some embodiments, the WGPs are grouped into specified shader arrays, and the shader arrays are grouped into specified shader engines. If all WGPs in a shader array are placed in the low-power mode, then the entire shader array (including any logic used to feed work to or otherwise support the WGPs) are also placed into the low-power mode, thus conserving power.

The power configuration sets the resources available for processing workloads at the GPU 100. In at least some cases, it is desirable that the device driver 103 is aware of the available resources at the GPU 100, so that the device driver 103 is properly configured to provide an interface between those resources at applications executing at the GPU. Accordingly, as the scheduler 102 sets the power configuration of the shaders 105 and 106 based on the workload indicators 107, it is useful for the device driver 103 to be notified of the particular power configuration that is in place, and for the device driver 103 to be configured to use the available resources. To simplify the notification and configuration process, in some embodiments the GPU stores a set of virtual GPUs (vGPU) 110. Each vGPU (e.g., vGPU 111, 112) is a set of data indicating the available resources for a different power configuration of the shader engines 105 and 106.

In response to setting a particular power configuration at the shader engines 105 and 106, the scheduler 102 selects the corresponding vGPU from the set of vGPUs 110 and exposes the GPU 100 to the device driver 103 as the selected vGPU. That is the scheduler 102 notifies device driver 103 of the selected vGPU, so that the GPU 100 appears to the device driver 103 as if the GPU 100 were a physical GPU with the only the resources indicated by the selected vGPU. For example, any processing elements that are in the low-power mode are not indicated in the selected vGPU, so that these processing elements do not appear to the device driver 103 to be physically available.

To further illustrate, in some embodiments the device driver 103 maintains a list of GPUs and corresponding resources associated with each GPU in the list. Further, the device driver 103 includes a device ID for each GPU in the list. In response to a driver reset, the device driver 103 sends a query to the GPU 100 for a device ID. In response, the scheduler 102 provides the device ID corresponding to the selected vGPU. The GPU 100 therefore appears to the device driver 103 to be a physical GPU with the resources indicated by the provided device ID. For example, in some embodiments a module such as firmware executing at a microcontroller, a hypervisor, or system software receives a request for the selected vGPU and readies the vGPU for operation. The module resets the GPU if the current configuration does not match the requested vGPU and reconfigures the parameters of the GPU 100 to match that of the selected vGPU. The module then notifies the device driver 103 that the vGPU is ready to accept commands. By exposing each different power configuration as a vGPU, the GPU 100 is able to employ multiple different power configurations without requiring extensive redesign of the device driver 103, thereby simplifying implementation of the different configurations.

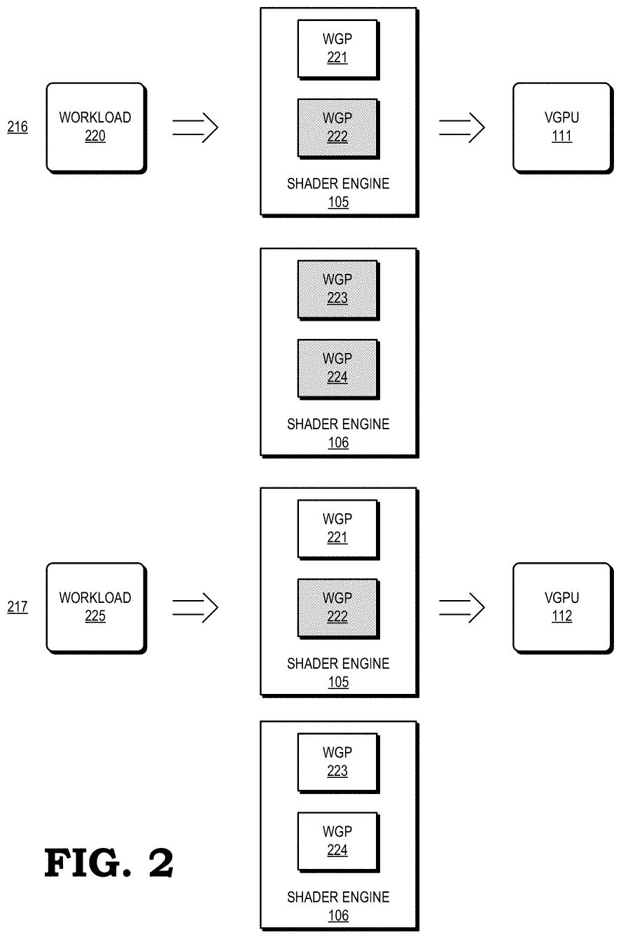

FIG. 2 illustrates a block diagram illustrating an example of the GPU 100 exposing different vGPUs to the device driver 103 based upon different identified workloads in accordance with some embodiments. In the example of FIG. 2, the shader engines 105 each include two different WGPs, designated WGP 221 and WGP 222 for shader engine 105, and WGP 223 and WGP 224 for shader engine 106. FIG. 2 shows two different power configurations for the GPU 100 at two different times 216 and 217. The power mode of each WGP is denoted by the shading of the corresponding box, with clear (white) shading indicating that the WGP is in the active power mode and gray shading indicating that the WGP is in the low power mode.

In the depicted example, at or about the time 216, the scheduler 102 identifies a workload 220 based on the workload indicators 107. The selected power configuration is such that WGP 221 is set to the active mode, while the WGPs 222, 223, and 224 are set to the low-power mode. Thus, at time 216 the workload indicators 107 indicate a workload (the workload 220) that is expected to demand relatively few processing elements of the shader engines 105 and 106 in order for the workload to be executed efficiently. Accordingly, the scheduler 102 selects a power configuration for the GPU 100 where a relatively high number of processing elements are placed in the low-power mode, thereby conserving power while providing sufficient resources for efficient processing of the workload 220.

In some embodiments, the scheduler 102 stores a table having a number of entries, with each entry includes a workload identifier, a set of workload indicators (or workload indicator ranges) corresponding to the workload identifier, and a power configuration. To select a power configuration, the scheduler 102 identifies the entry of the table corresponding to the workload indicators 107. That is, the scheduler 102 identifies the entry of the table that stores a set of workload indicators matching the workload indicators 107, or the entry for which the workload indicators 107 fall into the ranges indicated by entry's set of workload indicators. The scheduler 102 then selects the power configuration stored at the identified entry. In some embodiments, the table is programmable by the device driver 103 or by other software. This allows, for example, an application to select the particular power configuration for a given workload, or for a given type of workload, so that the application can tailor the performance and power consumption of the GPU based on the particular application.

As indicated above, at time 216 the scheduler 102 selects a power configuration for the GPU 100 such that WGP 221 is set to the active mode, while the WGPs 222, 223, and 224 are set to the low-power mode. The scheduler 102 provides control signaling to the power control module 108 so that the WGPs 221-224 are set to the indicated power modes. In addition, the scheduler 102 determines that vGPU 111 corresponds to the selected power configuration, and therefore exposes GPU 100 to the device driver 103 as vGPU 111. For example, in some embodiments each entry of the above-described table at the scheduler 102 indicates a vGPU identifier corresponding to the power configuration associated with the entry. In response to selecting an entry and setting the GPU 100 to the corresponding power configuration, the scheduler 102 sends a reset signal to the device driver 103, initiating a driver reset. During the driver reset, the device driver 103 sends a query to the scheduler 102 to identify the device type of the GPU 100. In response, the scheduler 102 provides the device driver 103 with the identifier for the vGPU 111. The GPU 100 thus appears to the device driver 103 as a physical GPU with the resources corresponding to the resources that are in the active power mode. That is, the GPU 100 appears to the device driver 102 as a GPU that has the WGP 221, and does not have the WGPs 222, 223, and 224.

Subsequent to time 216, at a time 217, the scheduler 102 determines that the workload indicators 107 have changed such that a different workload, designated workload 225, is to be executed at the GPU 100. The workload 225 demands more processing resources relative to workload 225. Accordingly, and based on the workload indicators 107, the scheduler 102 selects a power configuration for the GPU 100 such that WGP 222 is placed in the low-power mode, while WGPs 221, 223, and 224 are placed in the active mode.

In response to selecting the power configuration for the workload 225, the scheduler 102 selects a vGPU, designated vGPU 112, corresponding to the selected power configuration. The scheduler 102 sends a reset signal to the device driver 103, initiating a driver reset. During the driver reset, the scheduler 102 provides the device driver 103 with the identifier for the vGPU 112. The GPU 100 thus appears to the device driver 103 as a physical GPU having the WGPs 221, 223, and 224, as these WGPs are in the active mode, and not having the WGP 222, as this WGP is in the low-power mode.

Accordingly, as illustrated by the example of FIG. 2, in some embodiments the scheduler 102 changes the power configuration of the GPU 100 based on the workload to be executed. Further, for each different power configuration, the GPU 100 is exposed to the device driver 103 as a different virtual GPU. That is, the GPU 100 appears to the device driver 103 as a different physical GPU for each different power configuration. This allows the power configuration of the GPU to be changed even in systems using device drivers that are not aware of or specifically designed to accommodate the different power configurations.

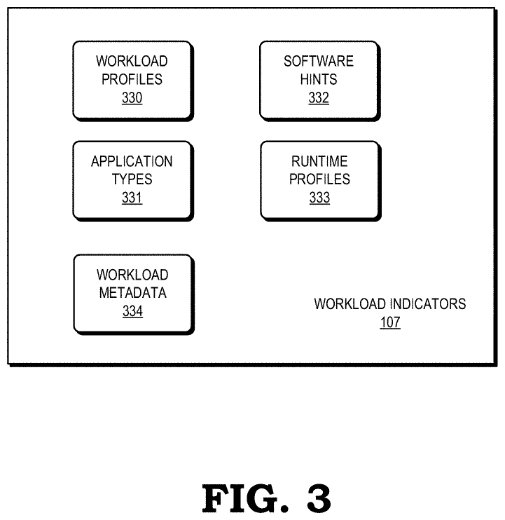

FIG. 3 illustrates an example of the workload indicators 107 in accordance with some embodiments. In the depicted example, the workload indicators 107 include workload profiles 330, application types 331, software hints 332, runtime profiles 333, and workload metadata 334. The workload profiles 330 include data collected in a test environment for one or more workloads. For example, in some embodiments, the GPU 100, or a GPU with a similar design as the GPU 100, is placed in processing system test environment and one or more applications are executed at the processing system, thereby generating one or more workloads at the GPU. The processing system records data indicative of the one or more workloads as the workload profiles 330, and a copy of the workload profiles 330 is stored at the GPU 100 during manufacture and initial configuration of the GPU 100.

For example, in some embodiments the workload profiles 330 is stored as a list of workload identifiers (IDs), with the different workload IDs organized into categories such as “light” workloads (workloads indicated in the test environment as demanding relatively few processing resources) and “heavy” workloads (workloads indicated in the test environment as demanding a relatively high amount of processing resources). When a workload is to be executed at the GPU 100, the scheduler 102 identifies the workload's workload ID and determines, based on the workload profiles 330, if the workload to be executed is categorized as a light or heavy workload. In response to determining the workload is designated as a heavy workload, the scheduler 102 selects a power configuration that places a higher number of processing elements in the active mode. In In response to determining the workload is designated as a light workload, the scheduler 102 selects a power configuration that places a higher number of processing elements in the active mode.

The application types 331 is a set of data indicating the expected workload associated with different application types. For example, in some embodiments the application types store a list of different types of applications, with the different types of applications categorized into light and heavy workload categories. When an application initiates execution, the device driver 103 indicates the application type to the scheduler 102. For example, in some embodiments a game application is categorized as a heavy workload application and a word processor is categorized as a light workload application. In response to the device driver 103 indicating the application type, the scheduler 102 accesses the application types 331 to determine if the application type is associated with light workloads or heavy workloads and selects a power configuration based on the determination. It will be appreciated that the heavy and light workload categories are examples only, and in other embodiments the different workload indicators 107 reflect a higher number of workload categories, such a light workloads, medium workloads, and heavy workloads.

The software hints 332 store data indicative of hints provided by software as to the expected workload to be executed at the GPU 100. For example, in some embodiment, software executing at the GPU provides, via the device driver 103, a hint as to the expected workload to the scheduler 102, wherein the hint indicates whether the expected workload is a heavy workload or a light workload. Based on the hint, the scheduler 102 selects a power configuration for the GPU 100. In some embodiments, a given application provides different hints to the scheduler 102 as the expected workload at the GPU 100 changes.

The runtime profiles 333 is a set of data reflecting performance information recorded at the GPU 100 during execution of different workloads. For example, in some embodiments, the GPU 100 includes a set of performance counters that record performance information, such as cache hits, memory accesses, operation dispatches, execution cycles, and the like, or any combination thereof. When a given workload is executed (e.g., a workload based on a particular draw command), the scheduler 102 records performance data at the performance counters, then stores that performance data for the workload at the runtime profiles 333. When the workload is executed again, the scheduler 102 uses the performance data for the workload, as stored at the runtime profiles 333, to determine a type for the workload, such as whether the workload is a heavy workload or a light workload. For example, in some embodiments, the scheduler 102 compares the performance data to one or more specified or programmable thresholds and based on the comparisons categorizes the workload as one of a heavy workload and a light workload. The scheduler 102 then selects a power configuration based on the workload category.

The workload metadata 334 stores data indicative of the expected resource requirements for a workload to be executed at the GPU 100. In some embodiments, the workload metadata is provided by an executing application via the device driver 103. For example, in some embodiments the application indicates, for a given workload, the number of draw calls, the number of dispatches, the number of primitives, the number of workgroups, and the like, or any combination thereof. In some embodiments, the scheduler 102 averages the workload metadata 334 over multiple units of work (e.g., over multiple executions of a given workload) for a better representation of the resource demands of a workload. The scheduler 102 compares the workload metadata 334 to one or more specified or programmable thresholds to determine a category for the workload (e.g., a light workload or a heavy workload), and then selects a power configuration for the GPU 100 based on the determined category.

It will be appreciated that, while the different types of workload indicators 107 are described individually above, in some embodiments the scheduler 102 employs a combination of the different types of indicators to determine a workload type for an executing workload. For example, in some embodiments the scheduler 102 employs both the workload metadata 334 and the application types 331 to determine the type of workload to be executed and selects the power configuration for the GPU 100 based on the determined type.

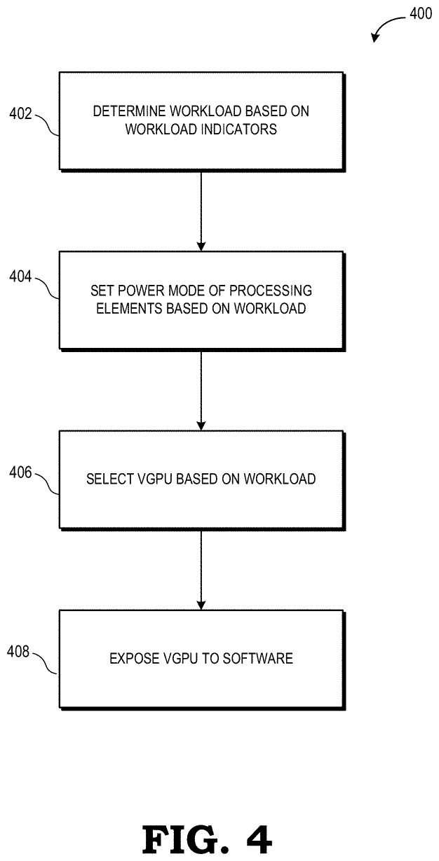

FIG. 4 is a flow diagram of a method 400 of exposing different virtual processing units to a device driver based upon different identified workloads in accordance with some embodiments. For purposes of description, the method 400 is described with respect to an example implementation at the GPU 100 of FIG. 1. However, in other embodiments the method 400 is implemented at a different type of processing unit or a processing unit having a different configuration.

At block 402, the scheduler 102 determines a workload to be executed at the GPU 100 based on the workload indicators 107. For example, in some embodiments, based on the workload indicators 107 the scheduler 102 determines a category for the workload to be executed, such as whether the workload is a heavy workload or a light workload.

At block 404, the scheduler 102 selects a power configuration for the GPU 100 based on the workload and based on the selected power configuration sends control signaling to the power control module 108 to set the power mode for each of the processing elements of the shader engines 105 and 106. For example, in some embodiments, if at block 402 the scheduler 102 determines that the workload to be executed is a light workload, the scheduler 102 selects a power configuration wherein a lower number of WGPs of the shader engines 105 and 106 are placed in the active mode, with the remaining WGPs set to the low-power mode. If the scheduler 102 determines that the workload to be executed is a heavy workload, the scheduler 102 selects a power configuration wherein a higher number of WGPs of the shader engines 105 and 106 are placed in the active mode, with the remaining WGPs set to the low-power mode.

At block 406, the scheduler 102 selects, from the virtual GPUs 110, the vGPU corresponding to the power configuration selected at block 404. At block 408, the scheduler 102 exposes the selected vGPU to the device driver 103. For example, in some embodiments the scheduler 102 sends a reset indication to the device driver 103, resulting in a driver reset. During the driver reset process, the device driver 103 requests a device identifier for the GPU 100. In response, the scheduler 102 provides an identifier for the selected vGPU, so that the GPU 100 appears to the device driver 103 as a physical GPU having only the processing elements that are in the active mode.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to identifying a first workload to be executed at a processing unit, configuring the processing unit to operate in a first power mode, wherein the first power mode corresponds to a first subset of processing elements of the processing unit being in a low-power mode; and
exposing the processing unit as a first virtual processing unit while the processing unit is in the first power mode.

2. The method of claim 1, further comprising:
in response to identifying a second workload to be executed at the processing unit, configuring the first processing unit to operate in a second power mode, wherein the second power mode corresponds to a second subset of processing elements of the processing unit being in the low-power mode; and
exposing the processing unit as a second virtual processing unit while the first processing unit is in the second power mode.

3. The method of claim 1, further comprising:
identifying the first workload based on metadata provided by an application associated with the first workload.

4. The method of claim 3, wherein the metadata indicates at least one of a number of draw calls, a number of thread dispatches, a number of graphics primitives, a number of workgroups, and a number of shader instructions to be executed at the processing unit.

5. The method of claim 3, wherein identifying the first workload comprises identifying the first workload based on an average of the metadata provided by the application over time.

6. The method of claim 1, further comprising:
identifying the first workload based on a stored profile of an application associated with the first workload.

7. The method of claim 1, further comprising:
identifying the first workload based on a runtime profile of an application associated with the first workload.

8. The method of claim 1, further comprising selecting the first subset of processing elements based on a software request.

9. The method of claim 1, further comprising selecting the first subset of processing elements from a set of programmable virtual processing unit profiles.

10. A method, comprising:
setting a processing unit to a first configuration based on a first workload to be executed at a processing unit; and
exposing the processing unit to a device driver as a first virtual processing unit while the processing unit is in the first configuration.

11. The method of claim 10, further comprising
setting the processing unit to a second configuration based on a second workload to be executed at the processing unit; and
exposing the processing unit to the device driver as a second virtual processing unit while the processing unit is in the second configuration.

12. A processing unit, comprising:
a set of processing elements;
a power control module to control a power mode of the set of processing elements; and
a scheduler configured to:
in response to identifying a first workload to be executed at the processing unit, configure the set of processing elements to operate in a first power mode, wherein the first power mode corresponds to a first subset of the set processing elements being in a low-power mode; and
expose the processing unit as a first virtual processing unit while the set of processing elements is in the first power mode.

13. The processing unit of claim 12, wherein the scheduler is configured to:
in response to identifying a second workload to be executed at the processing unit, configure the set of processing elements to operate in a second power mode, wherein the second power mode corresponds to a second subset of the set of processing elements being in the low-power mode; and
expose the processing unit as a second virtual processing unit while the first processing unit is in the second power mode.

14. The processing unit of claim 12, wherein the scheduler is configured to:
identify the first workload based on metadata provided by an application associated with the first workload.

15. The processing unit of claim 14, wherein the metadata indicates at least one of a number of draw calls, a number of thread dispatches, a number of graphics primitives, and a number of workgroups to be executed at the processing unit.

16. The processing unit of claim 14, wherein the scheduler is configured to identify the first workload based on an average of the metadata provided by the application over time.

17. The processing unit of claim 12, wherein the scheduler is configured to:
identify the first workload based on a stored profile of an application associated with the first workload.

18. The processing unit of claim 12, wherein the scheduler is configured to:
identify the first workload based on a runtime profile of an application associated with the first workload.

19. The processing unit of claim 12, wherein the scheduler is configured to select the first subset of processing elements based on a software request.

20. The processing unit of claim 12, wherein the scheduler is configured to select the first subset of processing elements from a set of programmable virtual processing unit profiles.
